(19) United States
(12) Patent Application Publication
(10) Pub. No.: US 2018/0210783 A1
(43) Pub. Date: Jul. 26, 2018

(54) INFORMATION PROCESSING APPARATUS, CONTROL METHOD OF THE SAME, AND STORAGE MEDIUM

(71) Applicant: CANON KABUSHIKI KAISHA, Tokyo (JP)

(72) Inventor: Naoto Sasahara, Toride-shi (JP)

(21) Appl. No.: 15/872,044

(22) Filed: Jan. 16, 2018

(30) Foreign Application Priority Data
Jan. 20, 2017 (JP) 2017-008785

(51) Int. Cl. G06F 11/07; G06F 13/42; G06F 9/4401; G06F 13/38; G06F 1/26

(52) U.S. Cl. CPC G06F 11/0793; G06F 13/4282; G06F 9/4405; G06F 13/385; G06F 2213/0042; G06F 9/4411; G06F 11/0745; G06F 2213/0016; G06F 1/266

(57) ABSTRACT

An information processing apparatus comprises a USB host I/F 108, and when a new USB device is connected to the USE host I/F 108, executes initialization processing (enumeration processing) to enable the USB device to be used. Also, when an error occurs during the initialization processing, the information processing apparatus stops the power supply to a Vbus signal line 202 of the USB device via the USB host I/F 108 and after a fixed time period elapses, restarts power supply to the Vbus signal line 202.

### BACKGROUND OF THE INVENTION

### Field of the Invention

The present invention relates to an information processing apparatus, a control method of the same, and a storage medium.

### Description of the Related Art

In information processing apparatuses such as host computers that incorporate a USB (Universal Serial Bus) I/F, it is possible to connect a USB storage, a USB card reader, a USB keyboard, and the like, and use them with the information processing apparatus as a single device. This is because a USB host controller is provided.

In devices up until USB 2.0, physically, four signal lines are comprised in a connector portion, as illustrated in FIG. 5, and these are respectively Vbus, GND, D+, and D−. The signal lines of Vbus and GND are signal lines for supplying a power supply from a host to the device, and are physically longer. The signal lines of D+ and D− are signal lines used to communicate commands and the like between the host and the device, and are physically shorter. Since the signal lines Vbus and GND and the signal lines of D+ and D− differ in physical length, when the device and the host are connected, the signal lines of Vbus and GND are connected first, and thereafter the signal lines of D+ and D− are connected. When the signal lines of D+ and D− are connected, the host detects the connection, and initialization processing (hereinafter, referred to as enumeration processing) is started.

In the enumeration processing, by the host transmitting several commands to the device, device properties are examined and communication with a device is established. During the enumeration processing, the device passes through four states: Powered, Default, Address, and Configured.

In Japanese Patent Laid-Open No. 2009-151415, a technique for transmitting a reset signal from a host to a device after a fixed wait period elapses from when the host and the device are connected in order to reliably cause enumeration processing to succeed has been proposed.

However, there is a problem as is recited below in the foregoing conventional technique. For example, there are various types of USB devices in circulation, and the individual devices are made differently depending on the vendor. Accordingly, even with devices for the same purpose, the behavior of the electrical operation may differ depending on the vendor. There are those in which, when a fixed time period elapses from when the Vbus signal line is connected prior to the connection of the D+ and D− signal lines upon connection to the host, both D+ and D− are pulled up to High, a recognition error occurs, and the USB device ceases to operate correctly. Since a device that falls into such a state cannot correctly process a command sent from the host, it is not possible for enumeration processing to succeed in the foregoing conventional technique. Accordingly, to successfully connect, it is necessary to reconnect the USE device, and the user must have the knowledge to do so.

### SUMMARY OF THE INVENTION

The present invention enables realization of a mechanism for automatically performing a reconnection in a state in which the USB device is physically connected even if a recognition error occurs at the time of a USB device connection.

One aspect of the present invention provides an information processing apparatus comprising: a USE host interface; an initializing unit configured to, when a new USE device is connected to the USE host interface, execute initialization processing that enables the USE device to be used; and a control unit configured to, when an error has occurred in the initialization processing, stop power supply to a Vbus signal line of the USB device via the USB host interface, and restart the power supply to the Vbus signal line after a fixed time period elapses.

Another aspect of the present invention provides a control method of an information processing apparatus having a USB host interface, the method comprising: when a new USB device is connected to the USB host interface, executing initialization processing that enables the USB device to be used; and executing control of, when an error has occurred in the initialization processing, stopping power supply to a Vbus signal line of the USB device via the USB host interface, and restarting the power supply to the Vbus signal line after a fixed time period elapses.

Still another aspect of the present invention provides a computer-readable storage medium storing a computer program for causing a computer to execute each step in a control method of an information processing apparatus having a USB host interface, the control method comprising: when a new USB device is connected to the USB host interface, executing initialization processing that enables the USB device to be used; and executing control of, when an error has occurred in the initialization processing, stopping power supply to a Vbus signal line of the USB device via the USB host interface, and restarting the power supply to the Vbus signal line after a fixed time period elapses.

Further features of the present invention will be apparent from the following description of exemplary embodiments with reference to the attached drawings.

### BRIEF DESCRIPTION OF THE DRAWINGS

FIG. 1 is a hardware configuration view of an image forming apparatus 100 according to an embodiment.

FIG. 2 is a view of a circuit configuration in which OFF/ON of a Vbus signal of a USB host 2.0 I/F is realized according to an embodiment.

FIG. 3 is a flowchart which describes reconnection processing of a device according to an embodiment.

FIG. 4 is a flowchart which describes enumeration processing according to an embodiment.

FIG. 5 is a view which illustrates a connector unit between a USB host and a USB device.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

<Configuration of the Information Processing Apparatus>

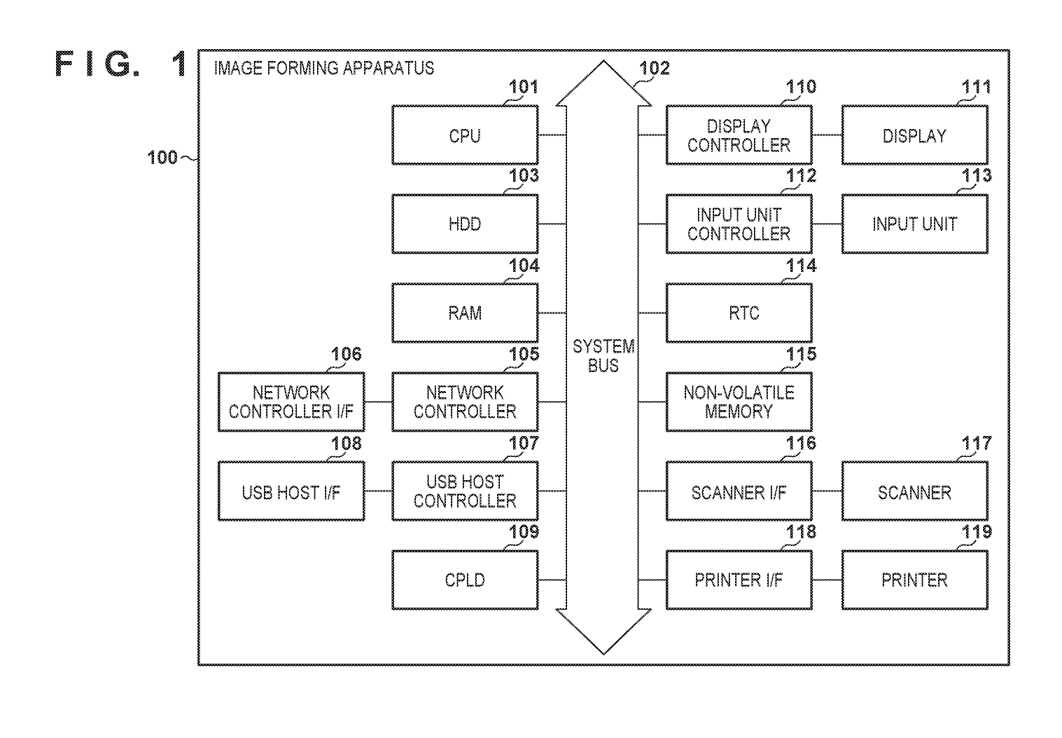

Below, description will be given for a first embodiment of the present invention. Firstly, with reference to FIG. 1, a hardware configuration of an image forming apparatus 100 which is an information processing apparatus according to the present embodiment will be described.

The image forming apparatus 100 comprises a CPU 101, an HDD 103, a RAM 104, a network controller 105, a network controller interface (I/F) controller 106, a USB host controller 107, and a USB host interface (I/F) 108. Also, the image forming apparatus 100 comprises a CPLD 109, a display controller 110, a display 111, an input unit controller 112, an input unit 113, an RTC 114, and a non-volatile memory 115. Furthermore, the image forming apparatus 100 comprises a scanner interface (I/F) 116, a scanner 117, a printer interface (I/F) 118, and a printer 119. Each load is connected via a system bus 102, and can transmit/receive data to/from each other.

The CPU (central processing unit) 101 runs software causing the image forming apparatus 100 to operate, and comprehensively controls each load. The CPU 101, via the system bus 102, accesses other units. Note that the system bus 102 is not merely a path between the CPU and each load, and that it is also a path by which other units can access each other. In the HDD (hard disk drive) 103, software of the image forming apparatus 100, and a database and temporary storage files necessary for the image forming apparatus 100 to operate are stored. While described as an HDD in FIG. 1, configuration may be as a large capacity non-volatile memory such as a Solid State Drive (hereinafter SSD) or the like. In the RAM (Random Access Memory) 104, programs of the image forming apparatus 100 are loaded, and there is a storage region for variables for when programs operate and data transferred by Direct Memory Access (hereinafter, DMA) from each unit.

The network controller 105 and the network controller I/F 106 control communication between the image forming apparatus 100 and other devices on a network. The USB host controller 107 and the USB host I/F 108 are USB hubs for controlling communication between the image forming apparatus 100 and a USB device. In FIG. 1, only one USB host I/F 108 is described, but there are actually multiple USB host I/Fs 108. The USB host I/F 108 is connected to a USB device using a USB cable. A USB device may be of a form in which it is directly connected without using a USB cable.

The display 111 displays a screen by which a user can confirm an operation state of the image forming apparatus 100. The display controller 110 controls displaying by the display 111. The input unit 113 is a user interface for receiving instructions from a user to the image forming apparatus 100. The input unit controller 112 controls the input unit 113. The input unit 113 specifically is an input system such as a keyboard, a mouse, numeric keys, a cursor keypad, a touch panel, and an operation unit keyboard. In a case where the input unit 113 is a touch panel, it is physically attached to the surface of the display 111.

The RTC (real-time clock) 114 has a clock function, an alarm function, and a timer function in the image forming apparatus 100. The non-volatile memory 115 is a rewritable memory that is not as large capacity as the HDD 103. The non-volatile memory 115 may be Static Random Access Memory (hereinafter, SRAM), Electrically Erasable Programmable Read Only Memory (hereinafter, EEPROM) or the like.

The CPLD 109, via the CPU 101, reads the Low/High status of a signal line on a base circuit. Alternatively, the CPLD 109 is a unit that enables the CPU 101 to change a Low/High status setting. The CPLD (Complex Programmable Logic Device) 109 is a programmable logic device, and is a unit that enables control of OFF/ON of a power relation in the image forming apparatus 100. Within the CPLD 109, there is a General Purpose input Output (hereinafter, GPIO). The CPU 101 enables OFF/ON of a power relation by changing a setting value in a GPIO register.

Also, the scanner 117 is connected to the image forming apparatus 100 via the system bus 102 and the scanner I/F 116. Furthermore, the printer 119 is connected to the image forming apparatus 100 via the system bus 102 and the printer I/F 118.

<Control Configuration>

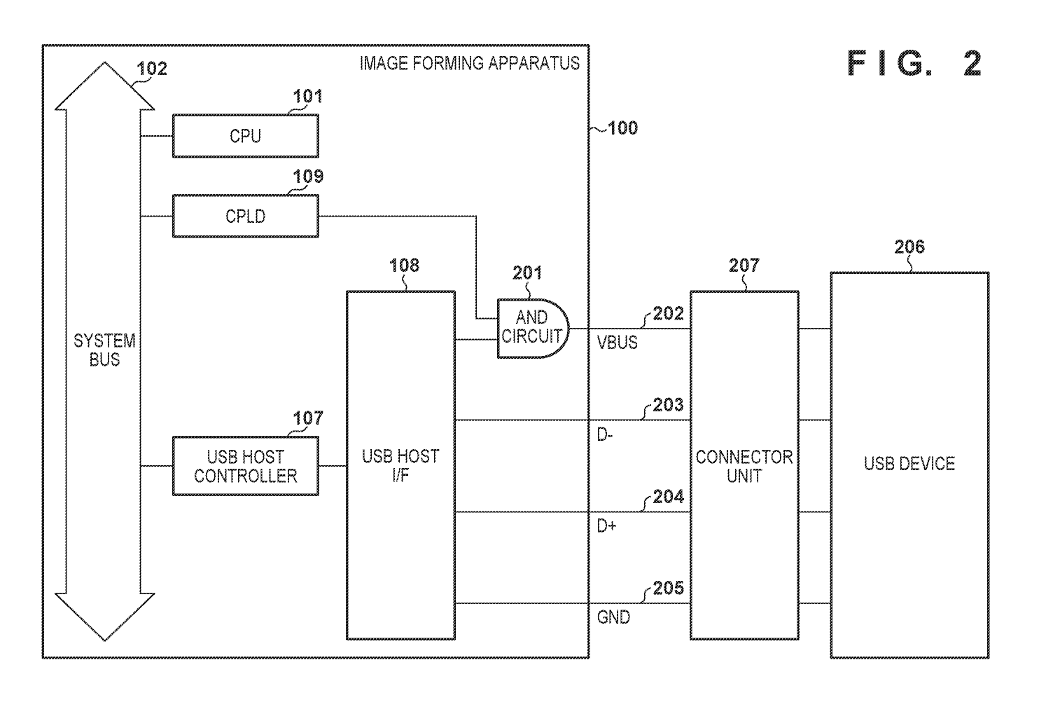

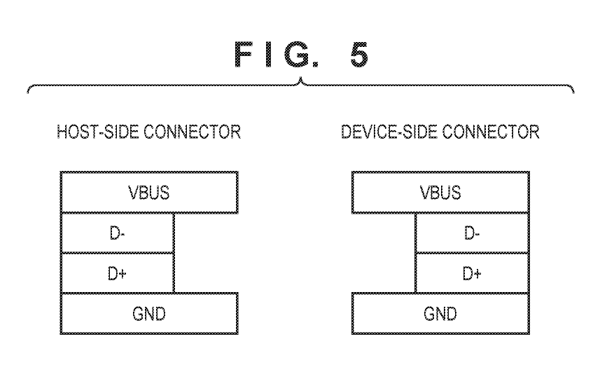

Next, with reference to FIG. 2, a control configuration that enables control of OFF/ON of a Vbus 202 by an instruction of the CPU 101 is described. As described above using FIG. 5, it is a specification of the USB standard that four signal lines are connected to a USB device 206. The Vbus 202 is a power line for supplying power to the USB device 206. A D− signal line 203 and a D+ signal line 204 are differential signal lines for flowing data to be communicated between the USB device 206 and the USB host controller 107. A GND 205 is a ground signal line. A connector unit 207 is a connector unit between the USB host I/F 108 and the USB device 206 as illustrated in FIG. 5.

An AND circuit 201 calculates a logical product between an output value from the GPIO inside the CPLD 109 which is controlled by an instruction by the CPU 101 and a Vbus output value which is outputted from the USB host I/F 108, and outputs the calculation result to the Vbus 202. By this, OFF/ON of the Vbus 202 which provides power to the USB device 206 is controlled. In FIG. 2, it is indicated that OFF/ON of Vbus is simply controlled using the AND circuit 201, but it is possible to control OFF/ON of Vbus using a high-side switch and an OR circuit.

<Processing Procedure>

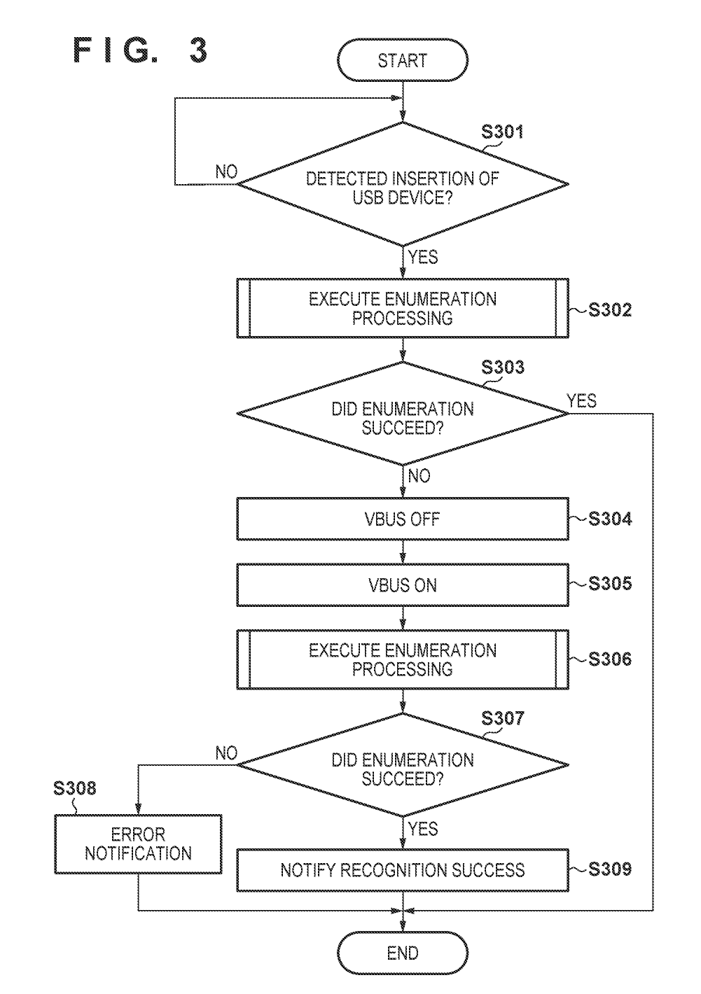

Next, with reference to FIG. 3, a processing procedure of the image forming apparatus 100 according to the present embodiment is described. The processing described below is realized by the CPU 101 reading a control program stored in the HDD 103 into the RAM 104 and executing it, for example.

Firstly, in step S301, the CPU 101 determines whether or not a USB device was inserted (connected) into the image forming apparatus 100. If the USB device 206 was connected to the USB host I/F 108, the voltage of either the D− signal line 203 or the D+ signal line 204 becomes High, and the USB host I/F 108 can detect that the device was connected. When the connection is detected, the USB host I/F 108 transmits an interrupt signal for the connection detection to the CPU 101 through the USB host controller 107. Accordingly, the CPU 101 determines that the USB device was connected to the image forming apparatus 100 when the interrupt signal is received. When the USB device is connected to the image forming apparatus 100, step S302 is advanced to, and if no connection is detected, the determination of step S301 is repeated.

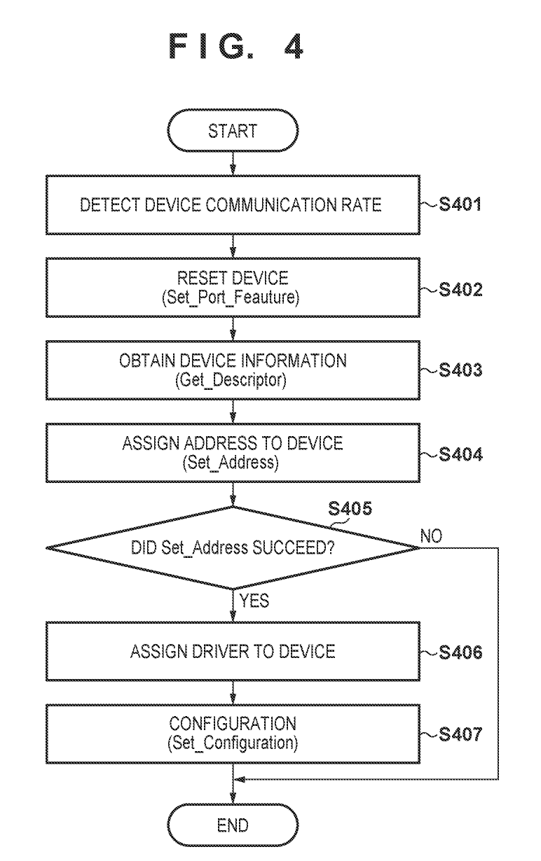

In step S302, the CPU 101 starts enumeration processing. The enumeration processing includes processing for device speed detection, reset (SET_PORT_FEATURE), device information obtainment (GET_DESCRIPTOR), and address assignment (SET_ADDRESS). Furthermore, the enumeration processing includes processing for device driver loading and configuration (SET_CONFIGURATION). The details of these processes are described later using FIG. 4 of the second embodiment. In the present embodiment, there is no particular need to describe the content of the enumeration processing and so description thereof is abbreviated.

Next, in step S303, the CPU 101 determines whether or not the enumeration processing succeeded. For example, here, since there is no normal USB device operation when the D− signal line 203 and the D+ signal line 204 are both pulled up to High, it is determined that an error has occurred. Upon success, the processing ends, and in a case when it does not succeed, step S304 is advanced to. In a case where a failure is detected in any of the foregoing enumeration processes, the CPU 101, in step S304, operates a register for the GPIO included in the CPLD 109 and outputs a zero signal to the AND circuit 201. At that time, even if the USB host controller 107 is operating, the output of the Vbus 202 becomes zero. When the signal level of the Vbus 202 becomes zero, even if physically connected, there is an electrical disconnection, and the Vbus of the USB device 206 is OFF. In other words, by the control of step S304, it is possible to achieve an effect similar to an operation of removing the USB device physically from the image forming apparatus 100.

If Vbus is OFF, after sufficient time (for example, 2 seconds) has elapsed in operation of the electrical circuit of the USB device, in step S305, the CPU 101 outputs a one signal to the AND circuit 201 by operating the GPIO register included in the CPLD 109 again. By this, it is possible to put the Vbus 202 in an ON state. By this processing, the Vbus 202 enters an electrically connected state, and supply of power to the USB device 206 is restarted. In other words, by the control of step S305, it is possible to achieve an effect similar to an operation of connecting the USB device physically to the image forming apparatus 100.

When the Vbus 202 is reconnected, the CPU 101, in step S306, again executes enumeration processing similar to step S302. Next, in step S307, the CPU 101 determines whether or not the enumeration processing succeeded. In a case where the enumeration processing of step S306 failed, step S308 is advanced to, and the CPU 101 displays a screen for notifying that recognition of the USB device 206 failed on the display 111 through the display controller 110. Meanwhile, in a case where the enumeration processing succeeds, in step S309, the CPU 101 displays a screen for notifying that recognition of the USB device 206 succeeded on the display 111 through the display controller 110, and the processing ends.

As described above, the information processing apparatus according to the present embodiment comprises the USB host I/F 108, and when a new USB device is connected to the USB host I/F 108, initialization processing (enumeration processing) for enabling the USB device to be used is executed. Also, when an error occurs during the initialization processing, the information processing apparatus stops the power supply to a Vbus signal line 202 of the USB device via the USB host I/F 108 and after a fixed time period elapses, restarts power supply to the Vbus signal line 202. By this, by software control, it is possible to first disconnect the Vbus signal line (in other words the power supply to the USB device) and restart when a fixed time period elapses, and it is possible to obtain an effect similar to a reconnection after physically removing the USB device. Thus, even if with a USB device that the host ceases to be able to recognize since it does not operate correctly when a fixed time period elapses from when the Vbus signal line is connected prior to the D+ signal line and the D− signal line connections, it is possible to execute the enumeration processing reliably again without the need to reinsert the device manually.

### Second Embodiment

Below, description will be given for a second embodiment of the present invention. In the first embodiment described above, a configuration is described in which, in a case where a failure is detected in any of the enumeration processes, enumeration processing is performed again by turning OFF/ON the Vbus power of the USE device 206. However, dedicated circuitry and built-in software are needed to be able to detect a failure at any time during enumeration processing. Accordingly, in the present embodiment, description is given of a mechanism for detecting a failure in processing at any time in the enumeration processing by simple processing. The hardware configuration in the present embodiment is similar to that of the first embodiment described above, and description thereof is abbreviated. Also, the processing for when a USB device is connected is as performed in the flowchart of FIG. 3, similarly to in the first embodiment described above, and description thereof is therefore abbreviated. In the present embodiment, since there is a feature in the processing of step S302 and step S306 of FIG. 3, that control will be mainly described.

With reference to FIG. 4, details of the enumeration processing of step S302 and step S307 according to the present embodiment will be described. The processing described below is realized by the CPU 101 reading a control program stored in the HDD 103 into the RAM 104 and executing it, for example.

Firstly, in step S401, the CPU 101 examines the voltages of the D− signal line 203 and the D+ signal line 204 via the USB host I/F 108. By this, the CPU 101 can detect whether the USE device 206 is a Low Speed device or a Full Speed device. In other words, the communication rate of the USE device 206 is detected here.

Next, in step S402, the CPU 101 transmits a request called SET_PORT_FEATURE to the USE host I/F 108 through the USE host controller 107 and requests resetting of the device. This reset request is performed by putting the voltage of both the D− signal line 203 and the D+ signal line 204 in a Low state for 10 milliseconds. During this reset, the USB host I/F 108 examines whether the USB device 206 supports High Speed by transmitting special signals called Chirp J and Chirp K.

When the USB device 206 returns from the reset state, the CPU 101, in step S403, transmits a GET_DESCRIPTOR request, and obtains information related to the USB device 206. The information obtained here is only information of a maximum packet length that the USB device 206 supports.

Next, the CPU 101 in step S404 transmits a SET_ADDRESS request to the USB device 206. The USB device 206, after receiving the SET_ADDRESS request, performs an acknowledgement to the USE host I/F 108. The CPU 101, in step S405, determines whether SET_ADDRESS succeeded by whether or not the acknowledgement was returned. In the case of success, step S406 is advanced to. On the other hand, in the case where no acknowledgement is sent back from the USB device 206, the enumeration processing is determined to have failed, and the enumeration processing is ended. When it is determined that the enumeration processing has failed in step S405, it is determined that the enumeration processing failed in step S303 and in step S307 of FIG. 3.

When the acknowledgement is received, the CPU 101, in step S406, assigns a driver to the USB device 206. Finally, the CPU 101, in step S407, transmits a SET_CONFIGURATION request, executes configuration processing for using the device, and ends the processing.

As described above, the information processing apparatus according to the present embodiment can easily detect an enumeration processing failure based on whether or not the device returned the acknowledgement to SET_ADDRESS. After detecting that the enumeration processing failed, similarly to in the above-described first embodiment, the CPU 101 performs enumeration processing again by turning OFF/ON the power of Vbus automatically by operating the GPIO register included in the CPLD 109. By this, it is possible to cause the device to be recognized reliably.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-008785 filed on Jan. 20, 2017, which is hereby incorporated by reference herein in its entirety.

What is claimed is:

1. An information processing apparatus comprising:
a USE host interface;
an initializing unit configured to, when a new USE device is connected to the USB host interface, execute initialization processing that enables the USB device to be used; and
a control unit configured to, when an error has occurred in the initialization processing, stop power supply to a Vbus signal line of the USB device via the USB host interface, and restart the power supply to the Vbus signal line after a fixed time period elapses.

2. The information processing apparatus according to claim 1, wherein the control unit, when both a D+ signal line and a D− signal line of the USB device are pulled up, determines that the error has occurred in the initialization processing.

3. The information processing apparatus according to claim 1, wherein
the initializing unit
detects a communication rate of the USE device, resets the USB device and then obtains information related to the USE device,
assigns an address to the USE device,
assigns a driver to the USB device, and
executes configuration processing for using the USB device.

4. The information processing apparatus according to claim 3, wherein the control unit determines that the error occurred in the initialization processing if, when assigning the address to the USB device, an acknowledgement is not received from the USB device.

5. The information processing apparatus according to claim 1, further comprising
a CPLD (Complex Programmable Logic Device) and
an AND circuit configured to calculate a logical product between output of the CPLD and output of the USB host interface, and output the calculation result to the Vbus signal line.

6. The information processing apparatus according to claim 5, wherein the control unit
stops the power supply to the Vbus signal line by controlling the CPLD to output a zero signal to the AND circuit, and after the fixed time period has elapsed, restarts the power supply to the Vbus signal line by controlling the CPLD to output a one signal to the AND circuit.

7. A control method of an information processing apparatus having a USE host interface, the method comprising:
when a new USB device is connected to the USB host interface, executing initialization processing that enables the USB device to be used; and
executing control of, when an error has occurred in the initialization processing, stopping power supply to a Vbus signal line of the USB device via the USB host interface, and restarting the power supply to the Vbus signal line after a fixed time period elapses.

8. The control method according to claim 7, wherein the control, when a D+ signal line and a D− signal line of the USB device are pulled up, determines that the error has occurred in the initialization processing.

9. The control method according to claim 7, wherein the initializing:
detects a communication rate of the USB device,
resets the USB device and then obtains information related to the USB device,
assigns an address to the USB device,
assigns a driver to the USB device, and
executes configuration processing for using the USE device.

10. The control method according to claim 9, wherein the control determines that the error occurred in the initialization processing if, when assigning the address to the USB device, an acknowledgement is not received from the USB device.

11. The control method according to claim 7, wherein the information processing apparatus comprises
a CPLD (Complex Programmable Logic Device) and
an AND circuit configured to calculate a logical product between output of the CPLD and output of the USB host interface, and output the calculation result to the Vbus signal line, and
the control
stops the power supply to the Vbus signal line by controlling the CPLD to output a zero signal to the AND circuit, and after the fixed time period has elapsed, restarts the power supply to the Vbus signal line by controlling the CPLD to output a one signal to the AND circuit.

12. A computer-readable storage medium storing a computer program for causing a computer to execute each step in a control method of an information processing apparatus having a USB host interface, the control method comprising:
when a new USB device is connected to the USB host interface, executing initialization processing that enables the USE device to be used; and
executing control of, when an error has occurred in the initialization processing, stopping power supply to a Vbus signal line of the USB device via the USB host interface, and restarting the power supply to the Vbus signal line after a fixed time period elapses.
